(19) United States
(12) Patent Application Publication
(10) Pub. No.: US 2024/0375538 A1
(43) Pub. Date: Nov. 14, 2024

(54) Charging Device, and Charging System and Charging Method for Electric Automobile

(71) Applicant: Autel Digital Power Co., Ltd., Shenzhen (CN)

(72) Inventor: Xiaojie SHEN, Shenzhen (CN)

(73) Assignee: Autel Digital Power Co., Ltd., Shenzhen, GD (CN)

(21) Appl. No.: 18/691,464

(22) PCT Filed: Aug. 3, 2022
(86) PCT No.: PCT/CN2022/109862

§ 371 Date: Mar. 13, 2024

(30) Foreign Application Priority Data
Sep. 14, 2021 (CN) 202111076543.8

(51) Int. Cl. B60L 53/66; B60L 53/18; B60L 53/30

(52) U.S. Cl. CPC B60L 53/66; B60L 53/18; B60L 53/305

(57) ABSTRACT

A charging device comprises a charging pile and a charging pile gun head connected via a transmission cable, wherein the charging pile gun head is provided with a pressing detection module, and the charging pile is provided with a control module connected to the charging pile gun head, and a wireless communication module and an output adjustment module connected to the control module. In operation, the charging device receives a pressing operation of a user, correspondingly outputs a charging instruction to the electric automobile to control the opening and closing of a charging base cover door, and adjusts the charging state when the charging pile gun head is connected to the charging base of the electric automobile. The process does not require the user to manually open or close the charging base cover door, and the user can adjust the output of the charging pile via the charging pile gun head.

The present application claims priority to the Chinese patent application No. 202111076543.8 entitled “charging device, and charging system and charging method for electric automobile” filed on Sep. 14, 2021, to the China National Intellectual Property Administration, the entire contents of which are incorporated herein by reference.

### TECHNICAL FIELD

The present application relates to the technical field of charging control of an electric automobile, and particularly to a charging device, and a charging system and a charging method for an electric automobile.

### BACKGROUND OF THE INVENTION

In the context of the global energy diversification development strategy, after years of technical precipitation, new energy automobiles and associated supporting charging facilities thereof are being accepted by more and more general consumers, and the inventory of electric automobiles and charging piles is also increasing. At the same time, as the new round of global science and technology revolution and industrial transformation has been booming, today's automobile consumers have not been satisfied with the traditional automobile as a transportation tool only, and the consumption form has changed from material type to service type, promoting new energy automobiles to be in the continuous pursuit of intelligent innovation in product form, user experience, etc.

A charging pile that can be used at home greatly improves the efficiency of the consumer's use of a vehicle compared to a conventional automobile that can only be gassed up at a gas station, and the charging pile is used with a high frequency. Generally, during usage, the vehicle needs to be charged once every 1 to 3 days. At present, no matter in the case of opening and closing a charging base cover opening of a vehicle, or when it is required to stop charging during the charging process, both situations require operations at the vehicle end and the pile end respectively, and then the gun needs to be pulled out and put back to the pile end. The cumbersome charging operation makes the user experience poor, and reduces the efficiency of using a vehicle. In particular, currently, most of the existing houses at home and abroad are built several years ago, and the existing electricity lines or street areas cannot meet the loading requirements for installing a charging pile. Once the charging is started, the charging pile will output according to the maximum power, which will lead to the overall trip and power failure of the residence.

### SUMMARY OF THE INVENTION

Embodiments of the present application provide a charging device, and a charging system and a charging method for an electric automobile that are easy to operate and can automatically adjust the output.

The object of the embodiments of the present invention is achieved by the following technical solution.

In order to solve the above technical problem, in the first aspect, an embodiment of the present invention provides a charging device comprising a charging pile and a charging pile gun head connected by a transmission cable, the charging device being connected to an electric automobile by the charging pile gun head and charging the electric automobile,

the charging pile gun head is provided thereon with:
a pressing detection module for receiving a pressing operation of a user so as to acquire pressing data;

and the charging pile is provided thereon with:
a control module connected to the charging pile gun head for outputting a

charging instruction according to the pressing data collected by the charging pile gun head,
a wireless communication module connected to the control module for communicatively connecting with the electric automobile and issuing a charging instruction to the electric automobile so that the electric automobile controls the charging base cover door to open and close, and
an output adjustment module connected to the control module for adjusting a charging state according to the charging instruction when the charging pile gun head is connected to a charging base of the electric automobile.

In some embodiments, the pressing detection module comprises:
a multi-channel pressure sensor combined in parallel by at least two pressure sensors for receiving a pressing operation of a user;
a pressure sensitive analog front end connected to the multi-channel pressure sensor for judging a pressing action of the user according to the pressing operation of the user and acquiring pressing data; and
a pressure sensitive communication module connected to the control module and sending the pressing data to the control module.

In some embodiments, the wireless communication module comprises:
an automobile diagnosis communication module communicatively connected to the electric automobile for acquiring automobile data of the electric automobile and issuing the charging instruction to the electric automobile; and
an application communication module for connecting to a cloud server and/or a mobile terminal to realize data communication.

In some embodiments, the charging device further comprises:
a collection detection module provided on the charging pile gun head and used for acquiring a charging parameter during a charging process.

In some embodiments, the charging device further comprises:
a display module provided on the charging pile for displaying the charging data.

In some embodiments, the display module comprises an indicator light bar provided on the charging pile for displaying a current limit value or current range of the charging pile.

In some embodiments, the charging device further comprises:
a storage module provided on the charging pile for storing user information and vehicle information.

In order to solve the above technical problem, in the second aspect, an embodiment of the present invention provides a charging system for an electric automobile, comprising:
The charging device according to the first aspect described above; and
an electric automobile provided with:
an automobile diagnosis module for achieving communication with the charging

device, acquiring a charging instruction issued by the charging device, and sending automobile data of the electric automobile to the charging device, and
a charging base cover door connected to the automobile diagnosis module and configured to open and close according to the charging instruction.

In some embodiments, the charging system further comprises:
a mobile terminal connected in wireless communication with the charging device for acquiring charging data.

In some embodiments, the charging system further comprises:
a cloud server connected in wireless communication with at least one of the charging devices for acquiring the charging data of each of the charging devices.

In order to solve the above technical problem, in the third aspect, an embodiment of the present invention provides a charging method for an electric automobile, which is applied to the charging system for an electric automobile according to the second aspect, the method comprising:
acquiring pressing data when a user holds the charging pile gun head in hand via the charging pile gun head so as to determine a charging requirement of the user and generate a corresponding charging instruction;
sending the charging instruction to the electric automobile via a charging pile so that the electric automobile controls a charging base cover door to open and close; and
charging the electric automobile according to the charging instruction when the charging pile gun head is connected to the electric automobile.

Compared with the prior art, the advantageous effects of the present invention are as follows: unlike the prior art, in an embodiment of the present invention, a charging device, and a charging system and a charging method for an electric automobile are provided; the charging device comprises a charging pile and a charging pile gun head connected via a transmission cable, the charging device is connected to the electric automobile via the charging pile gun head and charges the electric automobile, a pressing detection module is provided on the charging pile gun head, and the charging pile is provided with a control module connected to the charging pile gun head, and a wireless communication module and an output adjustment module respectively connected to the control module; when the charging device provided in the embodiment of the present invention is used to charge the electric automobile, a charging device receives a pressing operation of a user via a pressing detection module on a charging pile gun head to acquire pressing data so as to determine the charging requirement of the user, correspondingly outputs a charging instruction to an electric automobile so that the electric automobile controls the opening and closing of a charging base cover door, and adjusts the charging state according to the charging instruction when the charging pile gun head is connected to a charging base of the electric automobile; this process does not require the user to manually open or close the charging base cover door, and the user can realize the adjustment of the output of the charging pile via the charging pile gun head.

### BRIEF DESCRIPTION OF DRAWINGS

One or more embodiments are exemplified by drawings in the accompanying drawings corresponding to the embodiments. These exemplified descriptions do not constitute a limitation on the embodiments. Elements/modules and steps in the drawings having the same reference number designations are illustrated as similar elements/modules and steps, and unless otherwise particularly stated, the drawings do not constitute a proportional limitation.

FIG. 1 is a schematic view of a structure of a charging device provided by embodiment 1 of the present invention;

FIG. 2 is a schematic view of a structure of another charging device provided by embodiment 1 of the present invention;

FIG. 3 is a schematic view of a hardware circuit structure of a pressing detection module provided by embodiment 1 of the present invention;

FIG. 4 is a schematic view of a structure of a charging system for an electric automobile provided by embodiment 2 of the present invention;

FIG. 5 is a schematic flow chart of a charging method for an electric automobile provided by embodiment 3 of the present invention.

### DETAILED DESCRIPTION OF THE INVENTION

Hereinafter, the present invention will be described in detail with reference to specific embodiments. The following embodiments will aid those skilled in the art in further understanding of the present invention, but do not limit the invention in any way. It should be noted that several variations and modifications can be further made by a person of ordinary skills in the art without departing from the concept of invention. These are all within the scope of the present invention.

In order to make the object, technical solutions, and advantages of the present application more apparent, a more particular description of the present application will be rendered below with reference to the accompanying drawings and embodiments. It should be understood that the specific embodiments described herein are merely illustrative of the present application and are not intended to be limiting thereof.

It needs to be noted that, if not in conflict, the various features of the embodiments of the invention may be combined with each other and fall within the scope of the present application. In addition, although a functional module division is performed in a schematic view of an apparatus, and a logical order is shown in a flowchart, in some cases, the steps shown or described may be executed in an order other than the module division in the apparatus, or other than the order shown in the flowchart.

Unless defined otherwise, all technical and scientific terms used in the specification have the same meaning as commonly understood by one of ordinary skill in the art to which the present invention belongs. In the description, the terminology used in the description of the present invention is for the purpose of describing specific implementation modes only and is not intended to limit the present invention. As used herein, the term “and/or” includes any and all combinations of one or more of the associated listed items.

Further, the technical features involved in each implementation mode of the present invention described below can be combined with each other as long as they do not conflict with each other.

Specifically, an embodiment of the present invention will be further described with reference to the following drawings.

### Embodiment 1

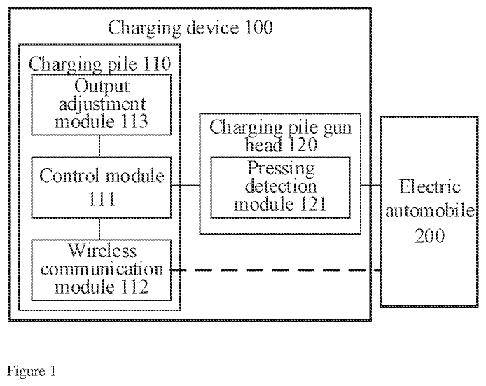

An embodiment of the present invention provides a charging device. Referring to FIG. 1, there is shown a structure of a charging device according to an embodiment of the present invention. The charging device 100 includes a charging pile 110 and a charging pile gun head 120 connected by a transmission cable. The charging device 100 is connected to and charges an electric automobile 200 through the charging pile gun head 120

The charging pile gun head 120 is provided with: a pressing detection module 121 for receiving the pressing operation of a user to acquire the pressing data; preferably, the pressing detection module 121 is arranged to be able to detect the sense of pressure of the pressing, determine the pressing operation of the user through the sense of pressure, and realize the control of the whole process from the start to the end of the charging through multi-channel sense of pressure interaction. Specifically, the pressing detection module 121 can also be a pressure sensor, a mechanical key, a membrane switch, a capacitance key, a dial switch, a knob, etc. which can be specifically provided according to actual needs.

In an embodiment of the present invention, the charging pile gun head 120 is an interface, connected to a transmission cable of the electric automobile 200, for directly interfacing electric energy and information with the electric automobile 200. The charging pile gun head 120 is connected to the charging pile 110 through a charging cable when the charging pile 110 and the electric automobile 200 use a standard connection mode C.

The charging pile 110 is an electric energy conversion apparatus for controlling and adjusting the power battery charging of the electric automobile 200, and is a main component for charging process control, and includes a direct current charging pile and an alternating current charging pile. The charging pile 110 is provided thereon with: a control module 111, a wireless communication module 112, and an output adjustment module 113.

The control module 111 is connected to the charging pile gun head 120 and is used for outputting a charging instruction according to the pressing data collected by the charging pile gun head 120; the control module 111 is a core collection, analysis, calculation, control and communication component in the charging device 100, and can realize functions such as charging control and data detection, so as to realize the control and protection of vehicle charging safety of the electric automobile 200.

The wireless communication module 112 connected to the control module 111 is used for communicatively connecting with the electric automobile 200 and issuing a charging instruction to the electric automobile 200 so that the electric automobile 200 controls the opening and closing of the charging base cover door 210; in an embodiment of the present invention, by notifying the electric automobile 200, through for example the wireless communication module 112, to control the charging base cover door 210 to open automatically when charging is needed and to close automatically when charging is not needed, the user experience problem that a user needs to bend down in the cockpit to open the charging base cover door in the existing traditional electric mobile can be solved such that the user can also perform charging without carrying a vehicle key.

Preferably, the wireless communication module 112 may be a component embedded in the charging pile 110 capable of achieving virtual communication interface (VCI) communication with the electric automobile 200, including but not limited to Bluetooth, WiFi, 4G, etc. and specifically, may be provided according to actual needs. Further, the wireless communication module 112 may further acquire overall vehicle data of the electric automobile 200, and the control module 111 may further judge whether the electric automobile 200 has abnormality based on the overall vehicle data, and send a charging instruction if there is no abnormality, and send a warning if there is abnormality.

The output adjustment module 113 connected to the control module 111 is used for adjusting a charging state according to the charging instruction when the charging pile gun head 120 is connected to the charging base 220 of the electric automobile 200; specifically, the output adjustment module 113 may adjust the current, voltage, etc. of the charging according to the charging instruction, and may also appropriately slow down the charging speed when the temperature is high which is caused by fast charging, so as to achieve temperature control. Further, with regard to an alternating current charging pile, when the intention of a user to start or stop charging, adjusting the maximum output capability of charging, etc. is recognized, the output adjustment module 113 can adjust the corresponding output frequency, voltage, duty cycle, etc. by means of Pulse Width Modulation (PWM) so as to notify the currently set state parameters of the vehicle; for a direct current charging pile, the parameter setting information can interact with the electric automobile 200 through a controller area network (CAN) or a Power Line Communication (PLC).

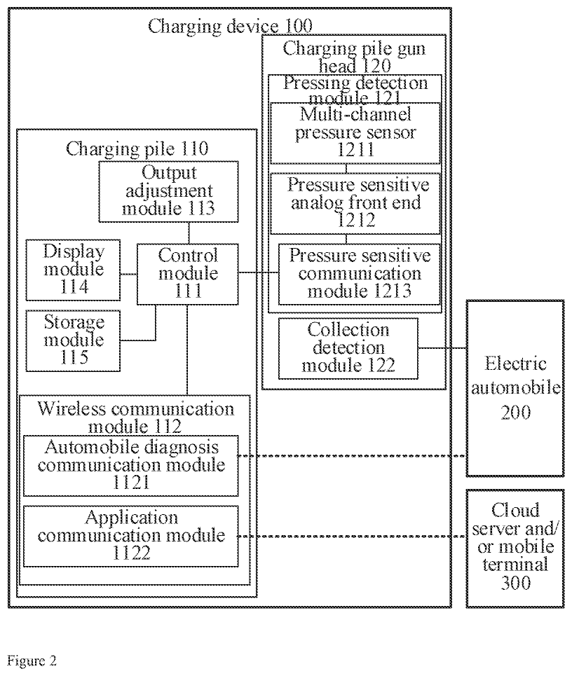

Further, refer to FIG. 2, which shows a structure of another charging device provided by an embodiment of the present invention. The pressing detection module 121 includes: a multi-channel pressure sensor 1211, a pressure sensitive analog front end 1212, and a pressure sensitive communication module 1213.

The multi-channel pressure sensor 1211 combined in parallel by at least two pressure sensors is used for receiving a pressing operation of a user; the multi-channel pressure sensor 1211 can be formed by connecting a piezoresistor and a standard resistor in series and then in parallel, and is similar to a Wheatstone bridge; when pressing is performed, the piezoresistor changes in the same direction and generates a pressure difference at a detection point; the circuit has very high sensitivity and can detect a slight resistance change, and is applicable to various material surfaces such as metal, wood, and plastic. A differential signal output by the multi-channel pressure sensor 1211 increases as the pressing force increases, and decreases as the pressing force decreases such that the user can judge the sliding direction of the user's finger through each pressure sensitive voltage change time sequence. Preferably, the multi-channel pressure sensor 1211 is adhered to the inner surface of the charging pile gun head 120, ensuring a product dustproof and waterproof grade design, and is provided in a thumb-moving area when a user grips the charging pile gun head 120 by hand, so that all operations can be completed by one finger when a gun is gripped by one hand.

Preferably, the multi-channel pressure sensor 1211 can be arranged in a position where an index finger or a thumb naturally holds a gun when a user holds the charging pile gun head 120 in a hand. At this time, the user only needs to hold the charging pile gun head 120 in a hand, and the control over the whole process from the beginning to the end of the charging can be completed by using only one finger by performing a long press, single click, multi-click, sliding and other actions at the charging pile gun head 120 where the multi-channel pressure sensor 1211 is provided.

The pressure sensitive analog front end (Analog Front End, AFE) 1212 is provided inside the charging pile gun head 120, and is connected to the multi-channel pressure sensor for judging a pressing action of a user according to a pressing operation of the user and acquiring the pressing data; a pressure sensitive algorithm is embedded in the pressure sensitive analog front end 1212, and a high-precision current sampling module thereof can calculate and obtain a small deformation of a pressure sensor according to voltage signals collected from multiple channels, so as to judge actions such as long pressing, single clicking, multi-click, and sliding of a user.

The pressure sensitive communication module 1213 is connected to the control module and sends the pressing data to the control module; specifically, the pressure sensitive communication module 1213 can be various wired or wireless communication modes such as I2C, SPI, WiFi, Bluetooth, 4G, Zigbee, and SmartMesh, and can be set according to actual needs.

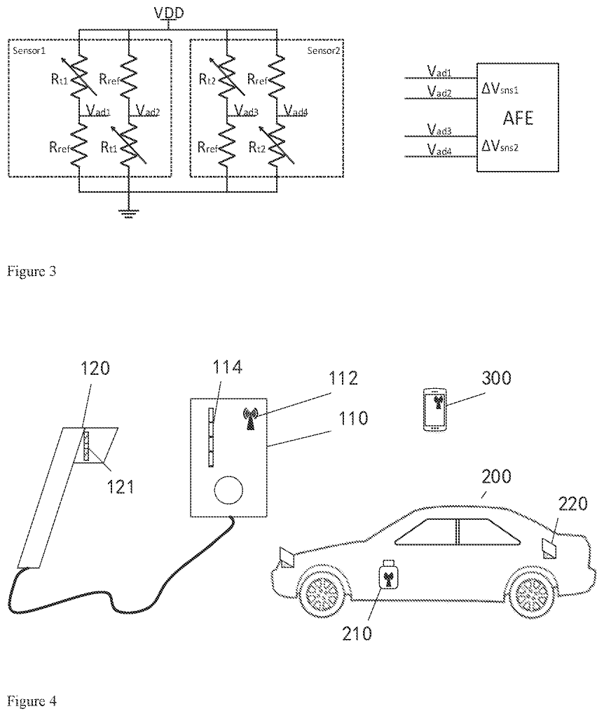

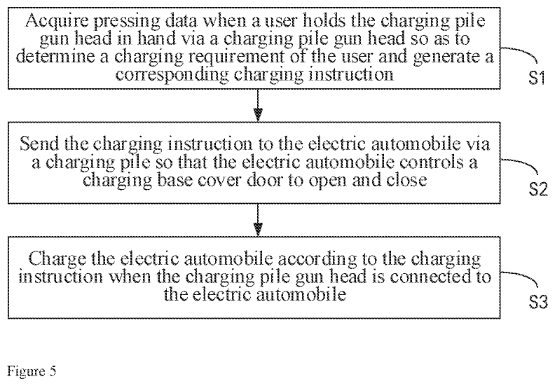

Specifically, referring to FIG. 3, a hardware circuit structure of a pressing detection module 121 provided by an embodiment of the present invention is shown, which is an example of a hardware circuit using two pressure sensitive combinations, and the principle of the two and more pressure sensitive combinations is the same; in FIG. 3, the supply voltage is VDD, the high-precision standard resistance value and the rated resistance value of the piezoresistor are R_{ref}, at the current moment of pressing, the resistance value of the piezoresistor is Rₜ and the resistance value change is Δr, then Rₜ=R_{Ref}−Δr; taking the pressure sensor sensor1 as an example, it can be obtained that the pressure sensitive output voltage signal difference at the current time t is:

$${V}_{ad 1} - {V}_{ad 2} = \frac{{R}_{ref} - ( {R}_{ref} - Δ r )}{{R}_{ref} + ( {R}_{ref} - Δ r )} \cdot VDD$$

where Δr is far less than R_{ref}, and it can be obtained from simplification that:

$$Δ {V}_{sns 1} = \frac{Δ r}{{R}_{ref}} \cdot \frac{VDD}{2} - k {ε}_{1} \frac{VDD}{2}$$

where k is the deformation coefficient and ε is the equivalent deformation quantity.

Therefore, the deformation quantities of the pressure sensors sensor1 and sensor2

can be obtained as ε₁ and ε₂, respectively. When the measured ε₁ or ε₂ value exceeds a certain threshold value and is recovered, it means that clicking is performed once; when the measured ε₁ or ε₂ value exceeds a certain threshold value and maintains such for a period of time, a long press is indicated; when the measured ε₁ exceeds a certain threshold value and is recovered, and then ε₂ exceeds a certain threshold value and is recovered, it indicates that sliding is performed from the pressure sensor sensor1 to sensor2, and vice versa.

Comprehensively considering various use habits of the users and the requirements for the response time of a charging function, the corresponding typical control functions of single-click, multi-click, sliding, and long-press are designed as shown in Table 1 below. Based on this principle, more and more complex human-machine interaction control logic can be developed, and this control mode can also be implemented on a terminal device application.

TABLE 1

| Pattern | Pressing operation | Control function |
|---|---|---|
| ./.. | Single-click/Multi-click | Start charging/stop charging |
| →/↑ | Slide right (swipe)/Slide up | Increase the maximum output |
| | (swipe) | current limit value |
| ←/↓ | Slide left (swipe)/Slide down | Decrease the maximum output |
| | (swipe) | current limit value |
| — | Long press | Open or close the charging base |
| | | cover door |

Further, with continued reference to FIG. 2, the wireless communication module 112 includes:
an automobile diagnosis communication module 1121 communicatively connected to the electric automobile 200 for acquiring automobile data of the electric automobile and issuing the charging instruction to the electric automobile; wherein the vehicle diagnostic communication module 1121 is preferably VCI communication, and a tool for allowing the electric automobile 200 and the charging pile 110 to communicate at the same time, and issuing a command to open or close a charging base cover door to the electric automobile 200 via the vehicle diagnostic communication module 1121 when the charging pile 110 judges that a user needs charging or the charging is completed;
and an application communication module 1122 for connecting with the cloud server and/or the mobile terminal 300 to realize data communication. The application communication module 1122 can be a module for realizing data communication with a cloud platform server or a smart phone terminal of a user, etc. by using communication modes such as WiFi, Bluetooth, 4G, CAN, serial port and Ethernet, and can be specifically set according to actual needs.

Further, with continued reference to FIG. 2, the charging device 100 further includes:
a collection detection module 122 provided on the charging pile gun head 120 and used for collecting a charging parameter during a charging process; wherein preferably, the charging parameter comprises a voltage, a current, a temperature, etc. during the charging process, so that the electric quantity information can be calculated, and the charging parameter can also be used for providing effective data for realizing temperature control, circuit protection, etc.

Further, with continued reference to FIG. 2, the charging device 100 further includes:
a display module 114 which is provided on the charging pile 110 and is used for displaying the charging data so as to indicate the state of the whole charging process of the user, or instruct the user to operate correctly, such as a vehicle charging base cover door open and close state, a charging gun inserted into a vehicle charging port state, a charging gun inserted into a pile and a charging gun returning port state, etc.; wherein, preferably, the display module 114 may comprise an indicator light bar, which is provided on the charging pile 110 and is used for displaying the current limit value or current range of the charging pile 110, and when it is used for displaying the current limit value of the charging pile 110, it can inform the user of the currently set maximum output current limit value of the charging pile, so as to facilitate the user to rationally adjust the limit value according to requirements. The display module 114 can also be a digital display nixie tube, or a digital display screen, etc. and can specifically be set according to actual needs.

Further, with continued reference to FIG. 2, the charging device 100 further includes:
a storage module 115 provided on the charging pile 110 for storing user information and vehicle information, wherein specifically, it can store charging modes corresponding to vehicles of different vehicle models, etc.; after the user information is determined, the storage module 115 is called to determine the vehicle type information about the vehicle required to be charged by the user, and then a communication protocol corresponding to an electric automobile of the vehicle model is acquired, and the communication with the electric automobile 200 is realized via the wireless communication module 112.

### Embodiment 2

An embodiment of the present invention provides a charging system for an electric automobile. Referring to FIG. 4, there is shown a structure of a charging system for an electric automobile according to an embodiment of the present invention. The charging system for an electric automobile includes: the charging device 100 according to embodiment 1; and an electric automobile 200 provided with:
an automobile diagnosis module 210 for communicating with the charging device 100, acquiring a charging instruction issued by the charging device 100, and sending automobile data of the electric automobile 200 to the charging device 100; wherein the electric automobile 200 and the charging device 100 preferably use VCI communication, and when the charging pile 110 judges that the user needs charging or the charging is completed, a command to open or close a charging base cover door is issued to the electric automobile 200 via the automobile diagnosis communication module 1121, and the electric automobile 200 accepts the charging command and executes the same via the vehicle diagnosis module 210;
and a charging base cover door 220 connected to the automobile diagnosis module 210 and configured to open or close according to the charging instruction. The charging base cover door 220 is a structure to protect the charging connector of the electric automobile 200 to be well-used and clean and tidy, and can also be used to avoid accidental leakage of high-voltage parts on the vehicle, thus opening only when it is required for charging. Generally, the Alternating current charging port and the Direct current charging port of the electric automobile 200 use the same cover door, which may be provided in front of or behind the vehicle.

The electric automobile 200 is a motor-driven automobile powered by electric energy, and the power battery system is the main energy storage apparatus mounted on the vehicle. In an embodiment of the present invention, the electric automobile 200 is preferably an electric automobile that can be charged by inserting a charging gun via an off-vehicle charging pile.

Further, with continued reference to FIG. 4, the charging system further comprises: a mobile terminal 300 connected in wireless communication with the charging device 100 and configured to acquire charging data, wherein the mobile terminal 300 is configured such that the user can acquire and view the charging data via the arrangement of the mobile terminal 300, and further, the user can also adjust the current charging state via the mobile terminal 300, for example, the scenario that the adjustment or control can be realized by a gesture action as shown in Table 1 above.

Further, the charging system may further include: a cloud server (not shown) connected in wireless communication with at least one of the charging devices 100 for acquiring charging data of each of the charging devices 100, wherein the cloud server is configured to be able to be connected in communication with multiple charging devices 100, acquire charging data of each of the charging devices 100, and realize unified management of charging devices 100 in the same area, of the same brand, etc.

### Embodiment 3

An embodiment of the present invention provides a charging method for an electric automobile, which can be applied to the charging system for an electric automobile according to embodiment 2 described above. Referring to FIG. 5, a flow chart of a charging method for an electric automobile according to an embodiment of the present invention is shown, the method including but not limited to the following steps:

step S1: acquiring pressing data when a user holds the charging pile gun head in hand via the charging pile gun head so as to determine a charging requirement of the user and generate a corresponding charging instruction;
wherein in an embodiment of the present invention, a pressing operation of a user on a charging pile gun head is acquired through the charging pile gun head, thereby detecting and identifying whether the user wants to start or stop charging; further, a pressing operation of a user on a charging pile gun head being acquired through the charging pile gun head during the charging process can also determine whether the user wants to increase or decrease the maximum output current limit value of the charging pile.

Step S2: send the charging instruction to an electric automobile via a charging pile so that the electric automobile controls the charging base cover door to open and close;
wherein upon determining that a user requires charging, further the charging instruction is sent to an electric automobile to enable the electric automobile to control the charging base cover door to open; alternatively, upon determining that the user does not require charging, an instruction is sent to the electric automobile to cause the electric automobile to control the charging dock cover door to close. Further, the electric automobile controlling the charging base cover door to open and close can also be controlled by the above-mentioned pressing operation of the user on the charging pile gun head; when it is detected that the user needs to open or close the vehicle charging base cover opening, the alternating current charging pile or the direct current charging pile issues a corresponding instruction to an automobile diagnosis communication module accessing the vehicle by means of VCI communication; after receiving the control command of the charging pile, the electric automobile realizes the action of opening or closing the vehicle charging base cover opening through the vehicle communication port.

Step S3: charge the electric automobile according to the charging instruction when the charging pile gun head is connected to the electric automobile.

When the charging pile gun head is connected to the electric automobile to charge or stop charging the electric automobile, the alternating current charging pile outputs or stops outputting power as required by the alternating current charging standard and notifies the charged vehicle via PWM output, and the direct current charging pile outputs or stops outputting power as required by the direct current charging standard and notifies the charged vehicle via CAN or PLC communication protocol.

Further, when the detection identifies that the user wants to increase or decrease the maximum output current limit value of the charging pile, the alternating current charging pile notifies the charged vehicle by increasing or decreasing the PWM output duty cycle as required by the alternating current charging standard, and the direct current charging pile notifies the charged vehicle via the CAN or PLC communication protocol as required by the direct current charging standard. At the same time, the currently set maximum output current limit value is displayed on the charging pile so that the user can know the current charging power at any time. Therefore, the user can make adjustments in time according to his/her own electricity demand.

In an embodiment of the present invention, a charging device, and a charging system and a charging method for an electric automobile are provided. The charging device comprises a charging pile and a charging pile gun head connected via a transmission cable, the charging device is connected to the electric automobile via the charging pile gun head and charges the electric automobile, a pressing detection module is provided on the charging pile gun head, and the charging pile is provided with a control module connected to the charging pile gun head, and a wireless communication module and an output adjustment module respectively connected to the control module; when the charging device provided in the embodiment of the present invention is used to charge the electric automobile, a charging device receives a pressing operation of a user via a pressing detection module on a charging pile gun head to acquire pressing data so as to determine the charging requirement of the user, correspondingly outputs a charging instruction to an electric automobile so that the electric automobile controls the opening and closing of a charging base cover door, and adjusts the charging state according to the charging instruction when the charging pile gun head is connected to a charging base of the electric automobile; this process does not require the user to manually open or close the charging base cover door, and the user can realize the adjustment of the output of the charging pile via the charging pile gun head.

It needs to be noted that the above-described apparatus embodiments are merely illustrative. The units described as separate components may or may not be physically separated, and the components displayed as units may or may not be physical units, that is, they may be located in one place, or they may be distributed on multiple network units. Some or all of the modules can be selected according to actual needs to achieve the purpose of the solution of the embodiment.

From the above description of the implementation modes, it will be clear to a person of ordinary skills in the art that the implementation modes can be implemented by means of software plus a general-purpose hardware platform, and of course, also by means of hardware. A person of ordinary skills in the art can understand that the implementation of all or part of the processes in the method of the above embodiments can be completed by instructing the relevant hardware through a computer program. The program can be stored in the computer-readable storage medium. When the program is executed, it can include the processes in the embodiments of the above methods. The storage medium may be a magnetic disk, an optical disk, a Read-Only Memory (ROM) or a Random Access Memory (RAM), etc.

Finally, it should be noted that: the above embodiments are merely illustrative of the technical solutions of the present invention, rather than limiting it; combinations of technical features in the above embodiments or in different embodiments are also possible under the idea of the present invention, and the steps can be implemented in any order; there are many other variations of the different aspects of the present invention as described above, which are not provided in detail for the sake of brevity; although the present invention has been described in detail with reference to the foregoing embodiments, those of ordinary skills in the art will appreciate that the technical solutions disclosed in the above-mentioned embodiments can still be modified, or some of the technical features thereof can be replaced by equivalents; such modifications or replacements do not depart the essence of the corresponding technical solution from the scope of the technical solutions of embodiments of the present invention.

1. A charging device, comprising a charging pile and a charging pile gun head connected by a transmission cable, the charging device being connected to an electric automobile by the charging pile gun head and charging the electric automobile,
wherein the charging pile gun head is provided thereon with:
a pressing detection module for receiving a pressing operation of a user so as to acquire pressing data;
the charging pile is provided thereon with:
a control module connected to the charging pile gun head for outputting a charging instruction according to the pressing data collected by the charging pile gun head,
a wireless communication module connected to the control module for communicatively connecting with the electric automobile and issuing a charging instruction to the electric automobile so that the electric automobile controls the charging base cover door to open and close, and
an output adjustment module connected to the control module for adjusting a charging state according to the charging instruction when the charging pile gun head is connected to a charging base of the electric automobile.

2. The charging device according to claim 1, wherein the pressing detection module comprises:
a multi-channel pressure sensor combined in parallel by at least two pressure sensors for receiving a pressing operation of a user;
a pressure sensitive analog front end connected to the multi-channel pressure sensor for judging a pressing action of the user according to the pressing operation of the user and acquiring pressing data; and
a pressure sensitive communication module connected to the control module and sending the pressing data to the control module.

3. The charging device according to claim 1, wherein the wireless communication module comprises:
an automobile diagnosis communication module communicatively connected to the electric automobile for acquiring automobile data of the electric automobile and issuing the charging instruction to the electric automobile; and
an application communication module for connecting to a cloud server and/or a mobile terminal to realize data communication.

4. The charging device according to claim 1, wherein the charging device further comprises:
a collection detection module provided on the charging pile gun head and used for acquiring a charging parameter during a charging process.

5. The charging device according to claim 1, wherein the charging device further comprises:
a display module provided on the charging pile for displaying the charging data.

6. The charging device according to claim 5, wherein
the display module comprises an indicator light bar provided on the charging pile for displaying a current limit value or current range of the charging pile.

7. The charging device according to claim 1, wherein the charging device further comprises:
a storage module provided on the charging pile for storing user information and vehicle information.

8. A charging system, comprising:
an electric automobile; and
a charging device which comprises a charging pile and a charging pile gun head connected by a transmission cable, the charging device being connected to the electric automobile by the charging pile gun head and charging the electric automobile.
wherein the charging pile gun head is provided thereon with:
a pressing detection module for receiving a pressing operation of a user so as to acquire pressing data;
the charging pile is provided thereon with:
a control module connected to the charging pile gun head for outputting a charging instruction according to the pressing data collected by the charging pile gun head,
a wireless communication module connected to the control module for communicatively connecting with the electric automobile and issuing a charging instruction to the electric automobile so that the electric automobile controls the charging base cover door to open and close, and
an output adjustment module connected to the control module for adjusting a charging state according to the charging instruction when the charging pile gun head is connected to a charging base of the electric automobile; and
wherein electric automobile provided with:
an automobile diagnosis module for achieving communication with the charging device, acquiring a charging instruction issued by the charging device, and sending automobile data of the electric automobile to the charging device, and
a charging base cover door connected to the automobile diagnosis module and configured to open and close according to the charging instruction.

9. The charging system according to claim 8, wherein the charging system further comprises:
a mobile terminal connected in wireless communication with the charging device for acquiring charging data.

10. The charging system according to claim 8, wherein the charging system further comprises:
a cloud server connected in wireless communication with at least one of the charging devices for acquiring charging data of each of the charging devices.

11. A charging method for an electric automobile, being applied to a charging system, wherein the electric system comprises a charging device which comprises a charging pile and a charging pile gun head connected by a transmission cable, the charging device being connected to the electric automobile by the charging pile gun head and charging the electric automobile:
wherein the charging pile gun head is provided thereon with:
a pressing detection module for receiving a pressing operation of a user so as to acquire pressing data;
the charging pile is provided thereon with.
a control module connected to the charging pile gun head for outputting a charging instruction according to the pressing data collected by the charging pile gun head,
a wireless communication module connected to the control module for communicatively connecting with the electric automobile and issuing a charging instruction to the electric automobile so that the electric automobile controls the charging base cover door to open and close, and
an output adjustment module connected to the control module for adjusting a charging state according to the charging instruction when the charging pile gun head is connected to a charging base of the electric automobile; and
the electric automobile is provided with:
an automobile diagnosis module for achieving communication with the charging device. acquiring a charging instruction issued by the charging device, and sending automobile data of the electric automobile to the charging device, and
a charging base cover door connected to the automobile diagnosis module and configured to open and close according to the charging instruction;
the method comprising:
acquiring pressing data when a user holds the charging pile gun head in hand via the charging pile gun head so as to determine a charging requirement of the user and generate a corresponding charging instruction;
sending the charging instruction to the electric automobile via a charging pile so that the electric automobile controls a charging base cover door to open and close; and
charging the electric automobile according to the charging instruction when the charging pile gun head is connected to the electric automobile.
